(19) United States
(12) Patent Application Publication
(10) Pub. No.: US 2011/0246742 A1
(43) Pub. Date: Oct. 6, 2011

(54) MEMORY POOLING IN SEGMENTED MEMORY ARCHITECTURE

(76) Inventors: Clark C. Kogen, Chadds Ford, PA (US); Anthony P. Matyok, Springfield, PA (US); Eugene W. Troxell, King of Prussia, PA (US); Sharon M. Mauer, West Chester, PA (US)

(21) Appl. No.: 12/752,563

(22) Filed: Apr. 1, 2010

(51) Int. Cl. G06F 12/02; G06F 12/00

(52) U.S. Cl. 711/170; 711/E12.001; 711/E12.002

(57) ABSTRACT

Methods and computing systems for managing memory are disclosed. One computing system implementing a memory management scheme includes a plurality of memory pools formed in a segment-addressable memory, each of the memory pools including one or more pool areas having a common size and a size class, wherein the size class defines a maximum amount of memory able to be allocated from the memory pool. The computing system includes a memory management system interfaced to the segment-addressable memory, the memory management system including one or more memory pool tracking lists configured to track usage of the plurality of memory pools.

### TECHNICAL FIELD

The present disclosure relates generally to storage in a segmented memory architecture. In particular, the present disclosure relates to creation and management of memory pools in a segmented memory architecture.

### BACKGROUND

In computing systems, memory management is responsible for coordinating and controlling use of memory. For example, memory management techniques are utilized for selecting a particular memory area for allocation (e.g., for storage of internal file information blocks, task attribute blocks and user created programmatic data structures of a particular type or size) or reclamation (e.g., in the case of deleted system data structures or otherwise deallocated memory space). A major issue in memory management, and storage allocation in general, is the efficient selection allocation of memory for storage of data structures of different types and sizes.

Computing systems have evolved to adopt either paged or segmented memory architectures. In a paged memory architecture, each process uses virtual addresses in a virtual address space, which is managed through pages in memory by the operating system software and memory management unit hardware. In a segmented memory architecture, each process addresses variable length memory data segments using indirect references (e.g., descriptors) to manage available physical addresses in a monolithic address space.

A major issue in both types of memory addressing architectures, a central problem is the management of memory fragmentation. Memory fragmentation relates to the inability to use available memory due to the arrangement of memory already in use. For example, memory fragmentation can relate to a state where unallocated, free space is “checker-boarded” throughout memory rather than in large contiguous chunks of available memory. Therefore, instances can arise in which sufficient memory space should be available, but an allocation request cannot be accommodated due to the fact that no contiguous memory area is available.

Memory fragmentation occurs in a number of ways. In one example, referred to as “external” fragmentation, a large number of small areas are available for allocation, but none of these areas are large enough to satisfy a current memory request. In a further example, referred to as “internal” fragmentation, additional memory is allocated than is actually requested, for example due to padding requirements, header requirements, cache alignment requirements, or other requirements.

To address the issue of memory fragmentation, memory management systems include algorithms for selecting memory for allocation carefully. For example, memory allocation algorithms attempt to allocate memory based on finding a best fit free space for the request. As the size and complexity of memory and computing systems increases, fragmentation issues increase exponentially. Memory management algorithms coincidentally increase in complexity and require additional overhead, causing increasing time delays in memory allocation.

As an additional drawback, during a memory allocation, a “lock” is placed on the entire memory space to prevent multiple allocations of the same memory space by different resources. This is particularly important in multiprocessor systems that access a common, contiguous, shared memory space. When one processor attempts to allocate memory, others are prevented from allocating memory due to this global memory lock, causing delay in an entire computing system, and preventing parallel processing.

For these and other reasons, improvements are desirable.

### SUMMARY

In accordance with the following disclosure, the above and other issues are addressed by the following:

In a first aspect, a computing system is disclosed that implements a memory management scheme. The computing system includes a plurality of memory pools formed in a segment-addressable memory, each of the memory pools including one or more pool areas having a common size and a size class, wherein the size class defines a maximum amount of memory able to be allocated from the memory pool. The computing system also includes a memory pool management system interfaced to the segment-addressable memory, the memory pool management system including one or more memory pool tracking lists configured to track usage of the plurality of memory pools.

In a second aspect, a method of managing memory in a computing system having a segment addressable memory is disclosed. The method includes allocating memory in a computing system. Allocating memory includes identifying a memory pool in which memory is to be allocated, the memory pool including at least one memory pool area and selected from among a plurality of memory pools having a common size and a size class, wherein the size class defines a maximum amount of memory able to be allocated from the memory pool. It also includes locking the memory pool, locating a memory pool area within the memory pool having an available entry, updating an availability of the memory pool, updating a status of the memory pool area, and unlocking the memory pool area.

In a third aspect, a computing system implementing a memory management scheme is disclosed. The computing system includes a plurality of memory pools formed in a segment-addressable memory, each of the memory pools including one or more memory pool areas including pool area control data and a plurality of pool objects, each of the memory pool areas having a common size and a size class, wherein the size class defines a size of each of the plurality of pool objects in that memory pool area. The computing system also includes a memory pool management system interfaced to the segment-addressable memory. The memory pool management system includes a plurality of memory pool tracking lists including a full area list, a partial area list, and an empty area list. The memory pool tracking lists are configured to track usage of the plurality of memory pools. The memory pool management system is also configured to, in response to a memory allocation request, select a memory pool, memory pool area, and pool object from which memory can be allocated.

### BRIEF DESCRIPTION OF THE DRAWINGS

FIG. 1 is a logical block diagram of a computing system in which aspects of the present disclosure can be implemented;

FIG. 2 is a logical block diagram of a processor and memory subsystem of a computing system in which aspects of the present disclosure can be implemented;

FIG. 3 is a logical block diagram of a unified, segment-addressed memory area illustrating memory pooling according to a possible embodiment of the present disclosure;

FIG. 4 is a logical block diagram of a memory pool area according to a possible embodiment of the present disclosure;

FIG. 5 is a logical block diagram of a memory pool management system capable of implementing memory pooling in a segmented memory architecture, according to a possible embodiment of the present disclosure;

FIG. 6 is a flowchart of an example method for allocating pooled memory, according to a possible embodiment of the present disclosure; and

FIG. 7 is a flowchart of an example method for deallocating pooled memory, according to a possible embodiment of the present disclosure.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general the present disclosure relates to creation and management of memory pools in a segmented memory architecture. Generally, memory pools refer to grouped, commonly managed memory areas used for storage and management of relatively small sized requests for memory. During operation of a computing system implementing memory pools according to certain embodiments disclosed herein, relatively small-sized objects can be placed into pools to be treated as a larger memory structure by an existing segment-based memory management system. Such a pooled arrangement allows for improved management of memory fragmentation, at least in part by supporting compaction of like-sized memory objects into a common memory pool.

In the various embodiments described herein, each memory pool is associated with a number of memory pool areas that can be allocated for data requests of a constant size for that memory pool. Memory pool areas correspond to individual blocks of memory to be used in a memory pool. In certain embodiments, the memory pool areas are all commonly sized, regardless of the memory pool to which the memory pool area belongs. This allows simple exchange of storage locations of the memory pool areas between memory and back storage, and dynamic reallocation for different sized data objects.

The memory structures disclosed in the memory pooling arrangement of the present disclosure can be allocated, deallocated, compacted, or swapped in location as needed, improving the flexibility of the memory storage system. Furthermore, the general purpose memory pools described herein support both kernel (operating system) and user objects in the same pool areas, improving memory efficiency. Additional advantages of memory pooling as described in the present disclosure, in particular relating to memory pooling in a system using segment-addressed memory, are described below.

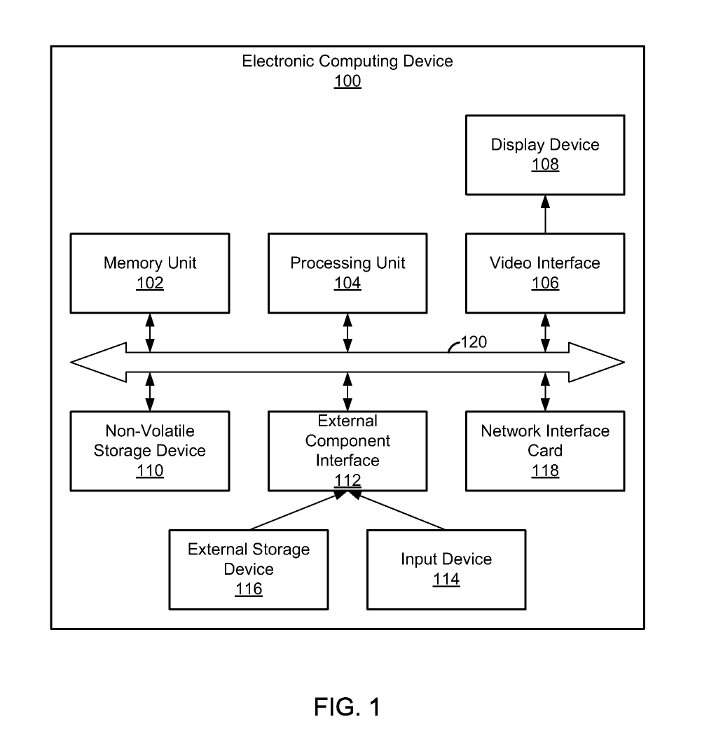

FIG. 1 is a block diagram illustrating example physical components of an electronic computing device 100, in which the memory pooling arrangements described herein can be implemented. A computing device, such as electronic computing device 100, typically includes at least some form of computer-readable media. Computer readable media can be any available media that can be accessed by the electronic computing device 100. By way of example, and not limitation, computer-readable media might comprise computer storage media and communication media.

As illustrated in the example of FIG. 1, electronic computing device 100 comprises a memory unit 102. Memory unit 102 is a computer-readable data storage medium capable of storing data and/or instructions. Memory unit 102 may be a variety of different types of computer-readable storage media including, but not limited to, dynamic random access memory (DRAM), double data rate synchronous dynamic random access memory (DDR SDRAM), reduced latency DRAM, DDR2 SDRAM, DDR1 SDRAM, Rambus RAM, or other types of computer-readable storage media.

In addition, electronic computing device 100 comprises a processing unit 104. As mentioned above, a processing unit is a set of one or more physical electronic integrated circuits that are capable of executing instructions. In a first example, processing unit 104 may execute software instructions that cause electronic computing device 100 to provide specific functionality. In this first example, processing unit 104 may be implemented as one or more processing cores and/or as one or more separate microprocessors. For instance, in this first example, processing unit 104 may be implemented as one or more Intel Core 2 microprocessors. Processing unit 104 may be capable of executing instructions in an instruction set, such as the x86 instruction set, the POWER instruction set, a RISC instruction set, the SPARC instruction set, the IA-64 instruction set, the MIPS instruction set, or another instruction set. In a second example, processing unit 104 may be implemented as an ASIC that provides specific functionality. In a third example, processing unit 104 may provide specific functionality by using an ASIC and by executing software instructions.

Electronic computing device 100 also comprises a video interface 106. Video interface 106 enables electronic computing device 100 to output video information to a display device 108. Display device 108 may be a variety of different types of display devices. For instance, display device 108 may be a cathode-ray tube display, an LCD display panel, a plasma screen display panel, a touch-sensitive display panel, a LED array, or another type of display device.

In addition, electronic computing device 100 includes a non-volatile storage device 110. Non-volatile storage device 110 is a computer-readable data storage medium that is capable of storing data and/or instructions. Non-volatile storage device 110 may be a variety of different types of non-volatile storage devices. For example, non-volatile storage device 110 may be one or more hard disk drives, magnetic tape drives, CD-ROM drives, DVD-ROM drives, Blu-Ray disc drives, or other types of non-volatile storage devices.

Electronic computing device 100 also includes an external component interface 112 that enables electronic computing device 100 to communicate with external components. As illustrated in the example of FIG. 1, external component interface 112 enables electronic computing device 100 to communicate with an input device 114 and an external storage device 116. In one implementation of electronic computing device 100, external component interface 112 is a Universal Serial Bus (USB) interface. In other implementations of electronic computing device 100, electronic computing device 100 may include another type of interface that enables electronic computing device 100 to communicate with input devices and/or output devices. For instance, electronic computing device 100 may include a PS/2 interface. Input device 114 may be a variety of different types of devices including, but not limited to, keyboards, mice, trackballs, stylus input devices, touch pads, touch-sensitive display screens, or other types of input devices. External storage device 116 may be a variety of different types of computer-readable data storage media including magnetic tape, flash memory modules, magnetic disk drives, optical disc drives, and other computer-readable data storage media.

In the context of the electronic computing device 100, computer storage media includes volatile and nonvolatile, removable and non-removable media implemented in any tangible, non-transitory method or technology for storage of information such as computer readable instructions, data structures, program modules or other data. Computer storage media includes, but is not limited to, various memory technologies listed above regarding memory unit 102, non-volatile storage device 110, or external storage device 116, as well as other RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the electronic computing device 100.

In addition, electronic computing device 100 includes a network interface card 118 that enables electronic computing device 100 to send data to and receive data from an electronic communication network. Network interface card 118 may be a variety of different types of network interface. For example, network interface card 118 may be an Ethernet interface, a token-ring network interface, a fiber optic network interface, a wireless network interface (e.g., WiFi, WiMax, etc.), or another type of network interface.

Electronic computing device 100 also includes a communications medium 120. Communications medium 120 facilitates communication among the various components of electronic computing device 100. Communications medium 120 may comprise one or more different types of communications media including, but not limited to, a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computer System Interface (SCSI) interface, or another type of communications medium.

Communication media, such as communications medium 120, typically embodies computer-readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

Electronic computing device 100 includes several computer storage media (i.e., memory unit 102, non-volatile storage device 110, and external storage device 116). Together, these computer storage media may constitute a single data storage system. As discussed above, a data storage system is a set of one or more computer-readable data storage mediums. This data storage system may store instructions executable by processing unit 104. Activities described in the above description may result from the execution of the instructions stored on this data storage system. Thus, when this description says that a particular logical module performs a particular activity, such a statement may be interpreted to mean that instructions of the logical module, when executed by processing unit 104, cause electronic computing device 100 to perform the activity. In other words, when this description says that a particular logical module performs a particular activity, a reader may interpret such a statement to mean that the instructions configure electronic computing device 100 such that electronic computing device 100 performs the particular activity.

One of ordinary skill in the art will recognize that additional components, peripheral devices, communications interconnections and similar additional functionality may also be included within the electronic computing device 100 without departing from the spirit and scope of the present invention as recited within the attached claims.

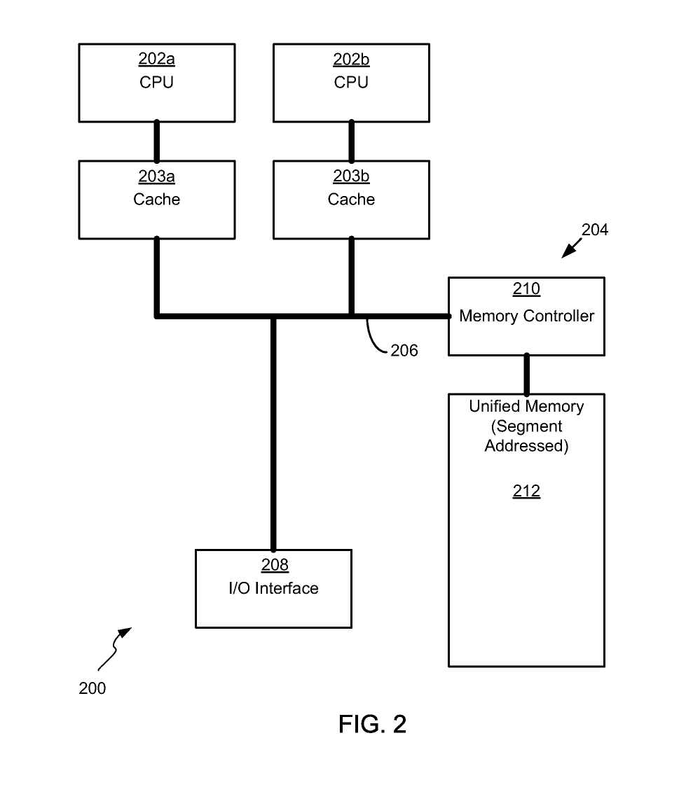

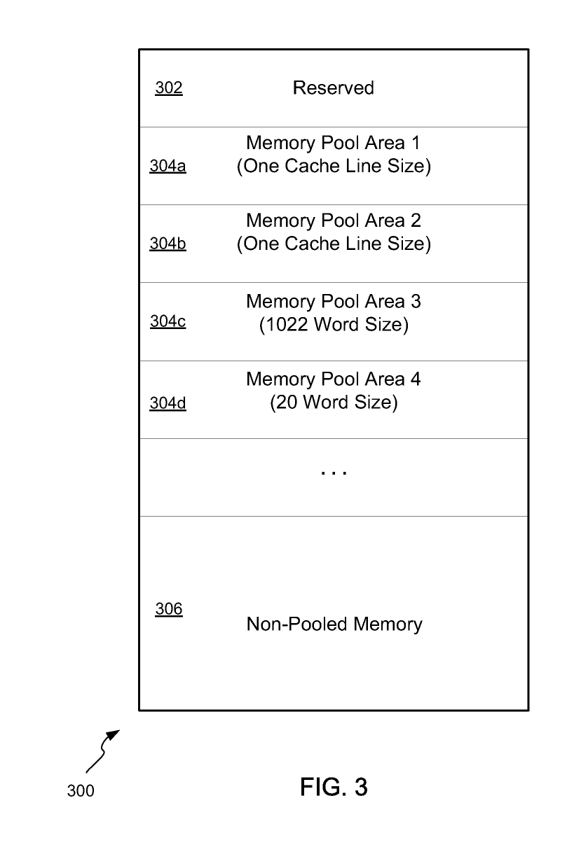

FIG. 2 is a logical block diagram of a computing subsystem 200 in which aspects of the present disclosure can be implemented. Certain features of the memory pooling arrangements described herein are discussed generally with respect to the computing subsystem 200; details regarding the structures, management/tracking systems, and operation of memory pools are discussed in further detail with respect to FIGS. 3-7.

The computing subsystem 200 includes a pair of microprocessors 202a-b and associated caches 203a-b communicatively connected to a memory subsystem 204 by a data bus 206. The microprocessors 202a-b and memory subsystem 204 are also, in the embodiment shown, communicatively connected to an I/O interface 208, for example providing an interface to remote storage (e.g., on a hard disk or remote memory system, or other system as described above in connection with FIG. 1).

In the embodiment shown, the microprocessors 202a-b can be any of a number of types of programmable circuits, as described above in FIG. 1. Each of the caches 203a-b, respectively, can have a default cache line size (e.g., typically 8-512 bytes). Also, in the embodiment shown, the memory subsystem 204 includes a memory controller 210 and memory 212. As described above with respect to FIG. 1, these memory system components can take many forms, consistent with the present disclosure.

The computing subsystem 200 illustrates an arrangement of a subsystem of an electronic computing system in which more than one programmable circuit (e.g., the microprocessors 202a-b) access the same, unified memory space using segment addressing. That is, the memory subsystem 204 can receive memory allocation requests from a microprocessor 202a-b or the I/O interface, with respect to any addressable memory space within the memory 212. The memory allocation requests can be of any of a variety of sizes, for example corresponding to one or more cache lines of one of the microprocessors. Other sizes of memory allocations or deallocations are possible as well.

For a memory allocation to successfully take place, an operating system is required to manage potential hardware conflicts between the components within the subsystem 200. For example, in the embodiments shown, microprocessors 202a and 202b cannot both access the same memory location at the same time; because each unallocated memory location is treated as an undifferentiated part of a unified memory, each memory allocation or deallocation causes a “lock”, preventing another microprocessor (or other processes executing on the same microprocessor) from accessing memory until the allocation or deallocation completes. By creating a pooled subsection of the memory space, and by assigning allocations of a particular size to a particular pool, only that pool must be locked during allocation or deallocation, allowing the other processor or process to access other memory areas during that allocation or deallocation, and avoiding the systemwide lock on memory resources.

Although in various embodiments of the present disclosure a wide variety of operating systems and hardware can be used, certain embodiments use segment-based memory addressing, such as is provided by the ClearPath MCP operating system provided by Unisys Corporation of Blue Bell, Pa. Other operating systems supporting segment-based memory addressing could be used as well.

Referring now to FIG. 3, a logical block diagram of a unified, segment-addressed memory area 300 is shown, illustrating memory pooling according to a possible embodiment of the present disclosure. The memory area 300 can, for example, correspond to a logical arrangement of memory 212 of FIG. 2. In the embodiment shown, memory area 300 includes a reserved memory block 302, a plurality of memory pool areas 304 and non-pooled memory 306.

The reserved memory block 302 can store any of a number of data objects associated with operation of the computing system implementing the memory management using memory pools as described herein. For example, the reserved memory block 302 can contain instructions or table relating to memory management or operation of a computing system that would be required prior to formation of memory pools. Alternatively, in certain embodiments, the reserved memory block 302 could itself be managed as a memory pool. For example, a memory pool could be created that includes particular requirements intended to accommodate operating system file information data structures or file data objects intended for or received from an I/O communication block (e.g. block 208 of FIG. 2) which may have requirements relating to their positioning on a cache line or particular word boundary. In such embodiments, additional “reserved” memory blocks could be included within the memory area 300 as well.

The memory pool areas 304 are each of a common size, and each have associated therewith a size class. The common size for each of the memory pool areas 304 relates to the overall footprint of the memory pool area, while the size class dictates the maximum size of a memory allocation that could occur from that memory pool area 304.

In the embodiment shown, four example memory pool areas 304a-d are shown, with a number of additional pool areas contemplated. Each memory pool area 304a-d has a common size, which is established prior to initial allocation of the memory pools. The common size can be any of a number of sizes; in an example embodiment, the memory pool areas can be any size up to 1022 words. Each pool area shown also has an associated size class. Memory pool areas 1 and 2 (304a and 304b) have a size class defined to be a single cache line (e.g. any single value defined by microprocessor characteristics, but typically about 8-512 bytes). Memory pool area 3 (304c) has a size class of 1022 words, and memory pool area 4 (304d) has a 20 word size class. In such an arrangement, memory pool area 304a and memory pool area 304b could be managed within a single memory pool, while memory pool area 304c and memory pool area 304d would be managed within separate memory pools from that pool relating to memory pool areas 304a-b. For example, for memory pool areas 304a-b, memory allocations of a cache line in size (or less, if a cache line memory size is determined to be the best fit size class memory pool in existence) could be allocated within either of the memory pool areas 304a-b, for example as determined using the memory management systems described below.

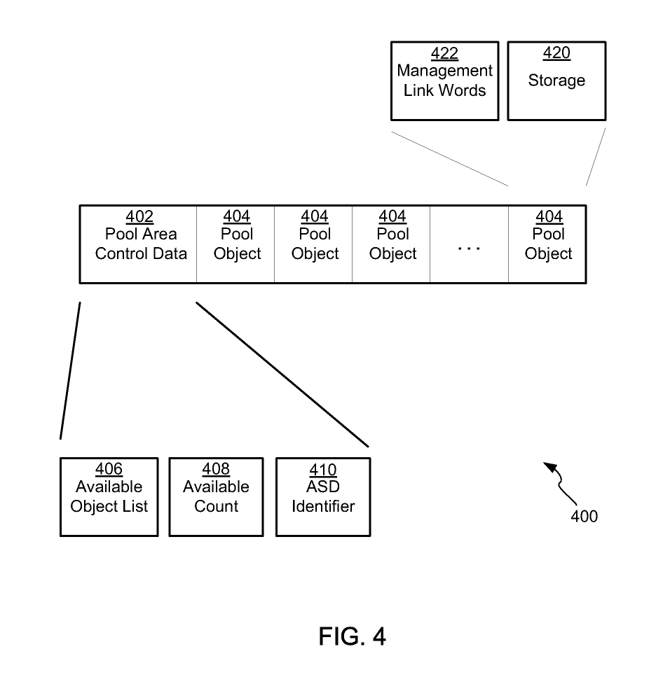

In certain embodiments, memory pools that include memory pool areas accommodating particular alignment requirements or non-portable memory requirements (e.g., certain system file related data objects) are referred to as “structure pools” which ensures that object sizes (described in FIG. 4, below) are aligned at regular offsets. In contrast, memory pools that do not have particular alignment requirements are also referred to herein as “size pools” and include memory pool areas that are not required to be aligned with a particular segment or offset addressing scheme.

Non-pooled memory area 306 corresponds to a memory area managed by traditional segment addressing in which no memory pool areas are formed. The non-pooled memory area 306 can therefore accommodate memory allocation requests of sizes exceeding the maximum memory pool area size and/or exceeding the size class of all of the memory pools. Due to the existence of the memory pools 304a-d, the non-pooled memory area 306 will primarily be allocated in large blocks, reducing the probability of interspersed small memory allocations causing internal or external fragmentation issues.

Although, in the embodiment shown, only four memory pool areas are explicitly shown, it is understood that more or fewer memory pool areas could be included, and more or fewer memory pools could be defined with respect to those memory pool areas. The number and size of memory pools and memory pool areas is a matter of design choice, and will depend upon the typical workload and fragmentation experienced on a computing system. In general, a computing system executing workloads requiring large blocks of memory resources and relatively few small blocks of memory resources might require formation of fewer memory pools than a similar system requiring allocation of a larger number of small memory blocks (thereby increasing the chance that, due to allocations and deallocations, a small block straddles an open area in memory and causes checkerboarded memory unable to respond to subsequent allocation requests for large memory blocks).

Referring to FIG. 3 generally, a number of observations about memory pool areas 304 are discussed, for reference with respect to the memory management systems described further below in FIGS. 4-7. The memory pool areas 304 can have sizes allocated at the time each program is compiled, such that a compiler can be programmed to determine the optimum size for a memory pool or the optimum size class for a memory pool. Additionally, the memory pool areas 304 support allocation of memory to kernel and user objects in the same pool area, and do not require separated memory structures for each. Additionally, due to the common size of each of the pool areas, pool areas can be swapped to a secondary storage (e.g., hard disk or secondary memory location, such as via an I/O interface) as desired to accommodate additional memory requests associated with a memory pool having available memory. Furthermore, due to flexibility with respect to memory locking as described above, it is possible to improve efficiency in compacting allocated memory into fewer pool areas by use of distributed, multiprocessor compaction algorithms. Other advantages of use of memory pools and common sized memory pool areas arise as well when used, for example, in combination with segment-based addressing systems.

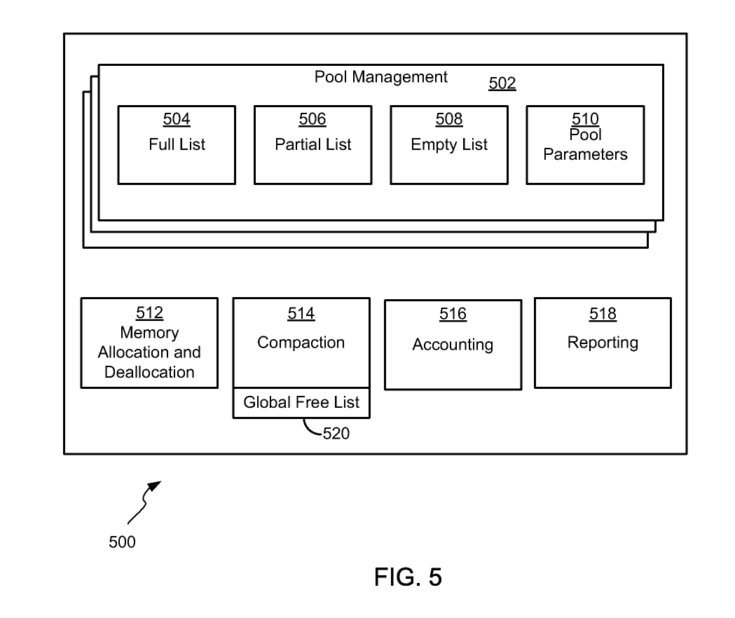

FIG. 4 is a logical block diagram of a memory pool area 400 according to a possible embodiment of the present disclosure. The memory pool area 400 illustrates additional details of an example embodiment of the memory pool areas described herein, such as memory pool areas 304a-d of FIG. 3. The memory pool area 400 appears to a standard memory management system as a single, large, in-use memory area. Each of the memory pool areas 400 included in a computing system can be assigned to a memory pool using a set of memory pool management and tracking tables, as explained below in further detail in conjunction with FIG. 5.

In the embodiment shown, the memory pool area 400 includes a pool area control data region 402 and a plurality of pool objects 404. The pool area control data region 402 includes information used to manage allocation of the objects within the region, such as a list of the available pool objects 406, a count of the available pool objects 408, and an Actual Segment Descriptor (ASD) number 410, locating the pool in memory. Other tracking information associating the memory pool area with a memory pool and with the objects stored within the memory pool area can be included as well.

Each of the plurality of pool objects 404 includes a fixed size storage area 420 that is available to be allocated in response to a request of that fixed size or smaller, depending upon whether the memory pool associated with the memory pool area 400 defines a size class that is a “best fit” for the request (i.e., barely large enough to accommodate the memory allocation request). The pool objects 404 also each include a set of management link words 422, which are used for locating the pool area control data region 402 during object deallocation (e.g., to update the list of available pool objects 406 and count of available pool objects 408).

FIG. 5 is a logical block diagram of a memory pool management system 500 capable of implementing memory pooling in a segmented memory architecture, according to a possible embodiment of the present disclosure. The memory pool management system 500 can be implemented, for example, within an operating system and using associated hardware such as is disclosed above with respect to FIGS. 1-2, and using the logical constructs described in connection with FIGS. 3-4.

The memory pool management system 500 includes a plurality of memory pool tracking structures 502 capable of tracking free and allocated memory space within each of the memory pools formed in a memory of a computing system. In the embodiment shown, the pool tracking structures include a plurality of lists of memory pool areas associated with a memory pool, with the lists indicating the status of those pools. For example, in the embodiment shown, the memory pool tracking structure 502 includes a full area list 504, a partial area list 506, and an empty area list 508. In certain embodiments, these lists 504-508 are implemented as doubly-linked lists of memory pool areas to allow for easy rearrangement of pool areas within the lists; in other embodiments, other memory structures (e.g., arrays, tables, or other types of linked lists) could be used. Additionally, each of the memory pool tracking structures 502 includes a set of pool parameters 510 tracking characteristics of the memory pool, such as: the size class of the memory pool areas in the memory pool, alignment requirements of the memory pool, offset information to a first pool object in the pool area, counters for each of the lists in the pool tracking structure, and other statistics. A particular embodiment of the memory pool tracking structure 502 includes the lists and parameters disclosed below in Table 1:

TABLE 1
Memory Pool Tracking Structure

| Item | Description |
|---|---|
| Full area list | Circular, doubly-linked list of fully allocated pool |
| | areas |
| Partial area list | Circular, doubly-linked list of partially allocated |
| | pool areas |
| Empty area list | Circular, doubly-linked list of empty pool areas |
| Object size | Maximum object size in words |
| Allocation size | Number of words charged to the stack for |
| | accounting |
| Alignment | Memory alignment requirements |
| First offset | Offset to the first pool object in the pool area |
| MemPool lock | Hardlock providing protection during object |
| | allocation and deallocation as well as pool area |
| | list management |
| Overall available count | Total number of available objects |
| Full list area count | Number of pools in the Full List |
| Partial list area count | Number of pools in the Partial List |
| Empty list area count | Number of pools in the Empty List |
| Overall inuse count | Number of inuse pool objects in all pool areas |
| Pool Area Size | Total number of words in the pool segment |
| Trailer Size | Unused portion of pool segment due to object size |
| Statistics | Various (optional) reporting statistics |

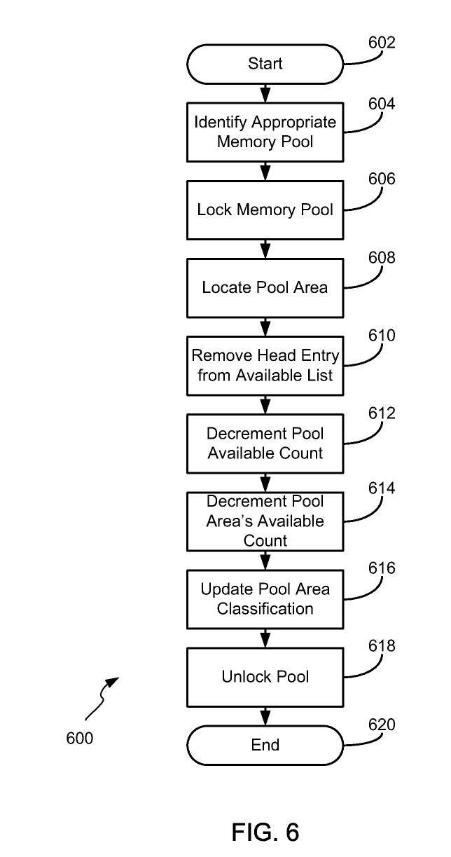

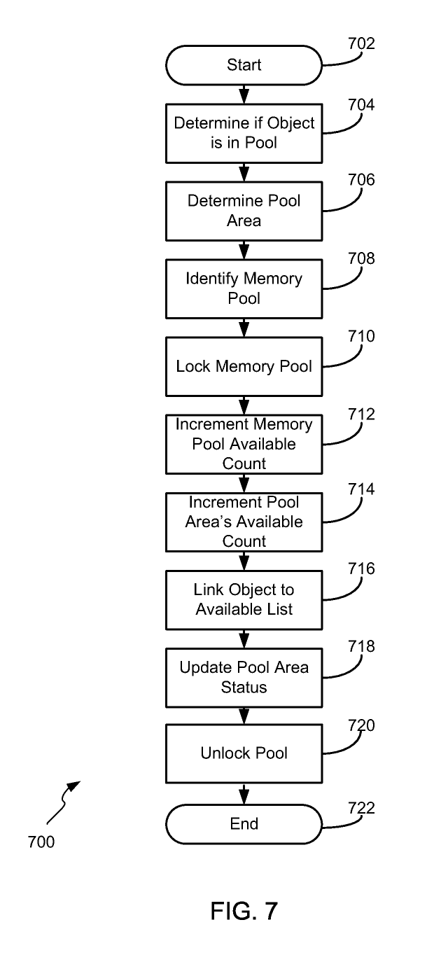

Additionally, in the embodiment shown, memory pool management system 500 includes a memory allocation module 512, a compaction module 514, an accounting module 516, and a reporting module 518. The memory allocation module 512 controls the method by which memory is allocated within the memory pools tracked by the memory pool tracking structures 502. For example, the memory allocation module 512 includes instructions that determine which memory pool to associate with a memory allocation request, and how to select a memory pool area from within that memory pool, as described in conjunction with FIG. 6. The memory allocation module 512 also includes instructions that determine the process by which memory is deallocated from within the memory pools, as in the example provided below in conjunction with FIG. 7. The memory allocation module 512 manages updating of the various lists and parameters included in the memory pool tracking structures 502 as memory allocation and deallocation take place. The memory allocation module 512 can also manage updating the memory pool tracking structures 502 during memory pool compaction and pool area deallocation and recycling.

The compaction module 514 manages compaction and related pool area de-allocation and recycling procedures typically associated with garbage collection. Garbage collection refers to a memory management mechanism that automatically recycles allocated memory that is no longer in use. In the context of the present disclosure, garbage collection includes adding de-allocated memory to the available memory to be used, as well as movement of memory segments that are in use, where possible, to create larger free spaces.

In some embodiments, the compaction module 514 periodically performs compaction, pool area deallocation and recycling processes to maintain a minimum area reserved for the memory pools within the overall memory of the computing system. For example, the compaction process performed by the compaction module 514 involves moving allocated pool objects from a partially filled pool area into another partially filled pool area within the same memory pool. During this consolidation of pool objects, if a partially filled pool area becomes full, an entry identifying that pool area will be moved from the partial area list 506 to the full area list 504 associated with that memory pool, and parameters 510 will also be adjusted accordingly (e.g., by incrementing the number of full pools). Similarly, if a partially filled memory pool area becomes empty, an entry identifying that memory pool area will be moved from the partial area list 506 to the empty list 508, and parameters 510 will be adjusted (e.g., by decrementing the number of partially full pools).

The compaction module 512 can, in certain embodiments, utilize existing compaction and garbage collection services provided by a system memory manager, such as the WS_SHERIFF service within the ClearPath MCP operating system provided by Unisys Corporation of Blue Bell, Pa.

In certain embodiments, the compaction module 512 can be performed in a distributed manner, such that different processors within a computing system (e.g. as shown in FIG. 2) perform the compaction process on separate memory pools, continuing until all pools are compacted.

In certain embodiments, the compaction module 512 also manages pool area deallocation. By pool area deallocation, it is intended that an entire pool area could be released to become unallocated space to be managed by a generalized memory manager. This could be the case if compaction of memory pools leads to a buildup of empty pool areas (as indicated by the empty area list 508 of each of the memory pool tracking structures 502). If a preset threshold number of empty memory pool areas are found in the empty area lists, the compaction module 512 can remove those empty memory pool areas to add them to a global free list 520. The global free list 520 relates to pool areas that remain as pool areas, but could be reassigned to a different pool and use a different size class and other parameters, thereby reallocating the memory pool area to a different memory pool. This is possible due to the common size of memory pool areas for each of the memory pools.

Additionally, in certain embodiments, if a threshold of memory pool areas in the global free list 520 is exceeded, the compaction module 512 is configured to remove one or more memory pool areas from the global free list, thereby releasing the space held by the pool to allow it to be deallocated and reallocated by the systemwide memory manager in response to other memory allocation requests. In certain embodiments, the compaction module 512 is configured to adjust the threshold at which empty memory pools are deallocated and returned to the system, for example, by lowering the number of empty memory pool areas maintained upon detection of low memory resources systemwide. Other embodiments are possible as well.

The accounting module 516 provides memory utilization accounting to collect statistics regarding memory pool usage. This information would be used to tune the memory pools that are allocated during future usage. For example, although in certain embodiments memory pools and associated memory pool areas are allocated as needed based on requests that are used to define the size and size class of those pools, in certain embodiments, pool areas can be preallocated, based at least in part on historical observations regarding the size of the memory pools and the size class of pool objects to be stored therein.

Additionally, a reporting module 518 allows reporting and display of memory pool usage for monitoring by a user. Various pieces of information could be extracted for display alongside other operational parameters of a computing system, such as the available pools, in use pools, fragmentation statistics, and other information.

FIG. 6 is a flowchart of an example method 600 for allocating pooled memory, according to a possible embodiment of the present disclosure. The method 600 is instantiated at a start operation 602, which corresponds to receipt of an initial request to allocate memory at a memory pool manager, such as the memory pool management system 500 of FIG. 5. The memory request will include a size of the memory to be allocated, as determined at compile time for the software seeking the memory allocation.

A pool identification operation 604 identifies an appropriately sized pool to accommodate the memory allocation request. The pool identification operation 604 will select a “best fit” memory pool to be associated with the allocation request. Preferably, a memory pool has a size class that matches the allocation request; if this is not the case, a closest memory pool could be selected having a size class slightly larger than the allocation request, to accommodate the request. The pool identification operation 604 will identify either a size pool or structure pool depending on the particular identified memory request as well.

A pool lock operation 606 will lock the selected memory pool to prevent other processes or systems from accessing the particular memory pool until the allocation successfully completes. Notably, the pool lock operation 606 prevents access of any of the memory pool areas associated with the memory pool (e.g., as identified by the memory pool tracking structure 502 associated with that memory pool). Other memory, including other memory pools, are accessible to other processes and resources within the computing system during memory allocation method 600.

A pool area location operation 608 locates an appropriate memory pool area from which to allocate memory. To minimize fragmentation, preferably a memory pool area that is partially free will be selected prior to selection of a free memory pool, to prevent creation of two (or more) partially free memory pool areas. If no partially free pool areas area available, an empty pool area can be used. If no empty pool areas exist as well, the pool area location operation can allocate a new pool area, for example from the global free list 520 of FIG. 5, for inclusion in the memory pool.

Following location of the pool area, the availability of the memory pool and status of the memory pool are updated. Specifically, a head entry update operation 610 removes the head entry from the list of available pool objects within the memory pool area (e.g., the list of the available pool objects 406 as illustrated in FIG. 4). A pool decrement operation 612 decrements the total number of pool objects available in the pool (e.g., the overall available count illustrated in Table 1, above). A pool area decrement operation 614 decrements the count of available pool objects (e.g., the count of the available pool objects 408 of FIG. 4). A pool area classification update operation 616 updates the pool classification, if necessary, within a memory pool tracking structure, such as the structure 502 of FIG. 5. For example, if the allocation caused a partially available pool or an empty pool to become full, an entry related to that memory pool area would be removed from the partial area list 506 or empty list 508, respectively, and added to the full area list 504. If the allocation caused an empty pool area to become non-empty, an entry related to the memory pool area would be removed from the empty list 508 and moved to the partial area list 506.

Once the pool parameters are updated and the pool object is allocated, an unlock operation 618 unlocks the memory pool, allowing other processes or systems to access the memory reserved as used by the memory pool. An end operation 620 signifies completion of a memory allocation.

FIG. 7 is a flowchart of an example method 700 for deallocating pooled memory, according to a possible embodiment of the present disclosure. The method 700 therefore relates generally to an inverse process to that described in FIG. 6, which relates to memory allocation.

The method 700 is instantiated at a start operation 702, which corresponds to receiving a request at a memory pool management system to deallocate memory within one of the managed memory pools. An object location operation 704 determines whether the object is present in a memory pool. If it is determined that the object is present in a memory pool, a pool area determination operation 706 determines which memory pool area within a memory pool contains the object. Once the memory pool area is located, a memory pool identification module 708 identifies the memory pool as requiring action. A lock operation 710 locks the memory pool (but not other portions of memory, as discussed with respect to lock operation 606 of FIG. 6), to prevent conflicts during deallocation of objects within that specific memory pool containing the object being deallocated.

Following location of the pool area, the availability of the memory pool and status of the memory pool are updated.

A pool increment operation 712 increments the total number of pool objects available in the pool (e.g., the overall available count illustrated in Table 1, above). A pool area increment operation 714 decrements the count of available pool objects (e.g., the count of the available pool objects 408 of FIG. 4). A link operation 716 links the available pool object to the list of available pool objects within the memory pool area (e.g., the list of the available pool objects 406 as illustrated in FIG. 4). A pool area classification update operation 718 updates the pool classification, if necessary, within a memory pool tracking structure, such as the structure 502 of FIG. 5. For example, if the deallocation caused a full pool or a partially available pool to become empty, an entry related to that memory pool area would be removed from the partial area list 506 or full list 504, respectively, and added to the empty list 508. If the deallocation caused a full pool area to become only partially full, an entry related to the memory pool area would be removed from the full area list 504 and moved to the partial area list 506.

Once the pool parameters are updated and the pool object is allocated, an unlock operation 720 unlocks the memory pool, allowing other processes or systems to access the memory reserved as used by the memory pool. An end operation 722 signifies completion of a memory deallocation.

Although a number of the operations of FIGS. 6-7 are discussed as occurring in a particular order, it is noted that certain of the operations could be performed in a differing order without affecting operation of a memory pool management system. For example, the order in which elements of a memory pool tracking structure are updated, or the order in which a memory pool or pool area is located and locked would not affect operation. Other reordering may be possible as well.

Referring now to FIGS. 1-7 generally, it is recognized that use of the memory pooling concepts disclosed herein provide for increased efficiency in memory allocation and lower fragmentation due to the separation and grouping of similar memory allocation requests into a common memory area. In an example implementation of the memory pooling concepts disclosed herein, a common usage scenario was used in which one or more large databases is hosted on a computing system, thereby requiring large amounts of memory to be dedicated to each database. For example, observed databases using 1 gigawords of memory required use of 1.8 million direct arrays for memory tracking As illustrated in the Table 2, below, an estimated drastic reduction of memory areas and ASDs is achieved when memory pools of 8192 words and having appropriate, differing size classes are used to store buffer data (1-64 k words), I/O control blocs (“IOCBs”, having a fixed size of 22 words) and control data (“IOCDs”, having a fixed size of 60 words):

TABLE 2
Estimate of Memory Area Reduction

| | | Structure | Structures per | Total Pool |
|---|---|---|---|---|
| | | Size | Pool Area | Areas |
| Structure | Number | (words) | (approximate) | Required |
| IOCD | 1.8 million | 22 | 372 | 4,839 |
| IOCB | 1.8 million | 60 | 136 | 13,236 |
| Event | 1.8 million | 13 | 630 | 2,858 |
| Total | 5.4 million | | | 20,933 |

Therefore, the system memory manager has fewer memory areas to track, since it tracks a pool as a single object, rather than a large number of small memory objects. Additionally, allocation time can be reduced in such an instance by an estimated 43% using a single threaded test allocating 500,000 events (a small data structure common during execution within a ClearPath MCP system).

Overall, it can be seen that a number of advantages exist relating to use of memory pools in a segmented memory system, according to the principles of the present disclosure. For example, memory allocation times decrease while maintaining management of fragmentation issues. Additionally, memory lock effects can be isolated to a single memory pool, reducing latencies caused by memory requests occurring during memory allocation/deallocation processes. Additional benefits are provided as well, as previously described.

The above specification, examples and data provide a complete description of the manufacture and use of the composition of the invention. Since many embodiments of the invention can be made without departing from the spirit and scope of the invention, the invention resides in the claims hereinafter appended.

1. A computing system implementing a memory management scheme, the computing system comprising:
a plurality of memory pools formed in a segment-addressable memory, each of the memory pools including one or more pool areas having a common size and a size class, wherein the size class defines a maximum amount of memory able to be allocated from the memory pool area;
a memory pool management system interfaced to the segment-addressable memory, the memory pool management system including one or more memory pool tracking lists configured to track usage of the plurality of memory pools.

2. The computing system of claim 1, wherein the plurality of memory pools includes at least one size pool and at least one structure pool.

3. The computing system of claim 1, wherein the size class differs between memory pools.

4. The computing system of claim 1, wherein each pool area includes pool area control data and a plurality of pool objects.

5. The computing system of claim 4, wherein each of the plurality of pool objects has a fixed size.

6. The computing system of claim 1, wherein the one or more memory pool tracking lists includes a full area list, a partial area list, and an empty area list.

7. A method of managing memory in a computing system having a segment addressable memory, the method comprising:
allocating memory in a computing system, wherein allocating memory includes:
identifying a memory pool in which memory is to be allocated, the memory pool including at least one memory pool area and selected from among a plurality of memory pools having a common size and a size class, wherein the size class defines a maximum amount of memory able to be allocated from the memory pool;
locking the memory pool;
locating a memory pool area within the memory pool having an available entry;
updating an availability of the memory pool;
updating a status of the memory pool area; and
unlocking the memory pool area.

8. The method of claim 7, wherein updating a status of the memory pool area includes decrementing a count of available pool area objects.

9. The method of claim 8, wherein updating an availability of the memory pool includes removing a pool object from a list of the available pool objects.

10. The method of claim 7, wherein updating a status of the memory pool area includes updating one or more of a plurality of memory pool tracking lists, the memory pool tracking lists including a full area list, a partial area list, and an empty area list.

11. The method of claim 7, wherein locating a memory pool area within the memory pool comprises:
allocating from a partially full memory pool area within the memory pool; and
upon determining that no partially full memory pool area exists, allocating from an empty memory pool area.

12. The method of claim 7, wherein locking the memory pool causes a lock of the at least one memory pool area associated with the memory pool without locking memory external to the at least one memory pool area.

13. The method of claim 7, further comprising:
deallocating memory in the computing system, wherein deallocating memory includes:
determining if an object stored in memory is in a memory pool;
If the object is stored in a pool object of a memory pool, determining a memory pool area in which the object is stored;
locking the memory pool including the memory pool area in which the object is stored;
updating an availability of the memory pool;
updating a status of the memory pool area; and
unlocking the memory pool.

14. The method of claim 13, wherein updating an availability of the memory pool includes incrementing a count of available pool area objects.

15. The method of claim 13, wherein updating a status of the memory pool area includes updating one or more of a plurality of memory pool tracking lists, the memory pool tracking lists including a full area list, a partial area list, and an empty area list.

16. The method of claim 13, wherein updating an availability of the memory pool includes linking the pool object to a list of available pool objects associated with the memory pool.

17. The method of claim 7, further comprising compacting the memory pool areas, wherein compacting includes consolidating data stored in two or more partially filled memory pool areas within a memory pool.

18. The method of claim 7, further comprising, while the memory pool is locked, allocating memory in a different memory pool selected from among the plurality of memory pools.

19. The method of claim 7, further comprising periodically assessing a number of empty memory pool areas, and, upon determining that an excess number of empty memory pool areas exist within a memory pool, eliminating one or more of the empty memory pool areas.

20. A computing system implementing a memory management scheme, the computing system comprising:
a plurality of memory pools formed in a segment-addressable memory, each of the memory pools including one or more memory pool areas including pool area control data and a plurality of pool objects, each of the memory pool areas having a common size and a size class, wherein the size class defines a size of each of the plurality of pool objects in that memory pool area;
a memory pool management system interfaced to the segment-addressable memory, the memory pool management system including a plurality of memory pool tracking lists including a full area list, a partial area list, and an empty area list, the memory pool tracking lists configured to track usage of the plurality of memory pools, the memory pool management system configured to, in response to a memory allocation request, select a memory pool, memory pool area, and pool object from which memory can be allocated.
